(19) United States
(12) Patent Application Publication
(10) Pub. No.: US 2022/0321457 A1
(43) Pub. Date: Oct. 6, 2022

(54) ROUTE DISCOVERY FOR FAILURE DETECTION IN COMPUTER NETWORKS

(71) Applicant: Microsoft Technology Licensing, LLC, Redmond, WA (US)

(72) Inventor: Surinder Hari, Sammamish, WA (US)

(21) Appl. No.: 17/221,045

(22) Filed: Apr. 2, 2021

(51) Int. Cl. H04L 12/703; H04L 12/707; H04L 12/717; H04L 12/741; H04L 29/12

(52) U.S. Cl. CPC H04L 45/28; H04L 45/22; H04L 45/42; H04L 45/74; H04L 61/1511

(57) ABSTRACT

Techniques for route discovery for failure detection in a computer network are disclosed herein. One example technique includes accessing an Intermediate System-to-Intermediate System database at a first network node to identify a connected second network node in the computer network. The example technique can also include determining whether the second network node has a Border Gate Protocol session with the first network node and if true, identifying a network prefix advertised by the second network node to the first network node and determining multiple network addresses in the identified network prefix that correspond to network reachable endpoints connected to the second network node. The example technique can then include executing a network test procedure to produce data indicating a connection status to the at least one of the multiple network addresses corresponding to network reachable endpoints connected to the second network node.

### BACKGROUND

Distributed computing systems typically include a computer network, such as a Wide Area Network (WAN) with routers, switches, bridges, firewalls, load balancers, and other types of network nodes to interconnect large numbers of servers, network storage devices, or other computing devices in various geographical areas. The network nodes can enable communications between the servers in different geographic areas by exchanging messages via network links across the WAN in accordance with suitable network protocols. The individual servers in turn can host one or more virtual machines (“VMs”), containers, virtual switches, or other virtualized functions to facilitate execution of suitable applications and providing individual users with desired computing services.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

WAN and other large computer networks can often have network nodes arranged in a hierarchical structure. For instance, in a WAN, regional computer networks can include many switches or routers interconnected to one another in a multi-level topology. A first regional computer network can include multiple first level switches interconnected to a second level switch. Multiple second level switches can then be interconnected to a third level switch. Multiple third level switches (sometimes referred to as “backbone switches”) can then interconnect multiple regional computer networks together to form a WAN. Thus, a first server connected to a first level switch in the first regional computer network can transmit messages to a second server connected to another first level switch in a second regional computer network via the first, second, and third level switches in each of the first and second regional computer networks. In other examples, a WAN may include three, four, five, or other suitable number of levels in the hierarchy.

Backbone switches, routers, and other network nodes can sometimes suffer various hardware or software failures. Such failures can interrupt communications traffic in the WAN and negatively impact system performance and user experience. In one example, a backbone switch may appear to have an active link to a regional computer network, e.g., a connection to the backbone switch appears to be active. However, the backbone switch may not be able to receive and/or forward any packets from/to the regional computer network. As such, even though the backbone switch may appear to be active, but in reality, the backbone switch may have failed. Such failures are sometimes referred to as grey failures.

Detecting and diagnosing grey failures can be time consuming and costly in large computer networks, such as a WAN. Network engineers sometimes spend hours to determine which one or more backbone switches have stopped transmitting packets even though appeared to be functional. One technique to automate detection of grey failures is by deploying dedicated diagnostic servers (often referred to as “canary servers”) in multiple regional computer networks of the WAN. The diagnostic servers can periodically transmit testing packets to one another via the WAN. If testing packets fail to arrive, the diagnostic servers can then indicate a network event or failure along particular network routes of the testing packets.

Deploying diagnosis servers though can be costly and ineffective. For example, a pair of diagnostic servers can typically only test limited numbers of network routes in the computer network because the source and destination of testing packets are fixed. Thus, the diagnosis servers may not detect grey failures along other network routes used by other servers in the WAN. Additional dedicated diagnostic servers may need to be deployed in each of the regional computer networks to expand testing of additional network routes. The additional dedicated diagnostic servers can incur high capital expenditure while not contributing to providing computing services to users. As such, deploying dedicated diagnostic servers can be costly and difficult to scale as the WAN expands.

Several embodiments of the disclosed technology can address certain aspects of the foregoing difficulties by implementing a network controller interconnected to a testing agent executing on individual network nodes (e.g., backbone switches or routers) in a computer network for detecting hardware/software failures in the computer network. In certain embodiments, the testing agent can be configured to access an Intermediate System-to-Intermediate System (ISIS) database on a network node to discover other network nodes interconnected to the network node in the computer network. For example, by querying the ISIS database, the testing agent executing on a first network node can determine IP addresses of a second network node connected to the first network node via the computer network. In other examples, the testing agent may also determine a name, an ID, a Media Access Control (MAC) address, or other suitable identifiers of the second network node.

Using the determined IP addresses, the testing agent on the first network node can be configured to determine whether the second network node exchanges routing information of endpoints connected with the first network node. In one embodiment, the routing information can be exchanged according to the Border Gateway Protocol (“BGP”) during a BGP session between the first and second network nodes. For example, when a BGP session is active, BGP neighbors, such as the first and second network nodes, can establish a TCP session on a designated port (e.g., 179). The first or second network node can also send keep-alive messages periodically, (e.g., every 60 seconds) to maintain the established BGP session. As such, the testing agent can be configured to determine whether a BGP session is active between the first and second network nodes by monitoring network traffic on the designated portion or via other suitable techniques. In response to determining that the first network node does not have a BGP session with the second network node, the testing agent can be configured to execute a network testing procedure from an IP address behind the first network node (e.g., an IP address of a server in the first regional network) and the IP address of the second network node. Examples of a network testing procedure can include executing a Ping command, traceroute command, File Transfer Protocol (FTP) performance test, Hypertext Transfer Protocol (HTTP) availability test, or other suitable testing techniques. The testing agent can then transmit data representing test results to the network controller for further analysis.

In response to determining that the first network node does have a BGP session with the second network node, the testing agent can be configured to query a BGP database on the first network node to determine one or more network prefixes that the second network node is advertising to the first network node. A network prefix is an aggregation of IP addresses. For example, IP addresses starting from 192.168.0.0 to 192.168.255.255 can be aggregated to 192.168.0.0/16, which indicate that the first sixteen bits of 192.168.0.0 are the prefix for these IP addresses to be served by the second network node. Thus, by advertising a network prefix of 192.168.0.0/16, the second network node is indicating to the first network node that all network traffic directed to any addresses covered by the network prefix, e.g., 192.168.0.0 to 192.168.255.255 are to be forwarded to the second network node. In other examples, the prefixes can have 32, 24, 12, 8, or any other suitable number of bits.

However, not all IP addresses covered by the advertised network prefixes are valid, i.e., associated with computing resources that can be reached via the computer network. Thus, upon obtaining the IP prefixes from the BGP database, the testing agent can be configured to consult a Domain Name System (DNS) server in the computer network to determine one or more IP addresses covered the obtained IP prefixes are valid IP addresses behind the second network node. A DNS server can access resource records that include a translation of a domain name into a numerical IP address. For example, a domain nameserver can translate domain name “www.example.com” to IP address 192.168.0.1. Routers, switches, or other computer services or devices can then access computing resources associated with this domain name (e.g., “www.example.com”) based on the translated IP address (e.g., 192.168.0.1). As such, resource records in the DNS server can identify IP addresses currently associated with domain names behind the second network node.

By querying the DNS server and scanning the resource records, the testing agent can be configured to determine that one or more IP addresses associated with the determined prefixes are valid. For instance, in the example above, the testing agent can be configured to determine that IP address 192.168.0.1 associated with the prefix 192.168.0.0/16 is a valid IP address because the IP address is associated with an active domain name. In another example, the testing agent can also determine that IP addresses 192.168.0.10, 192.168.0.11, and 192.168.0.50 are also valid IP addresses because these IP addresses individually correspond to active domain names.

Upon determining one or more valid IP addresses, the testing agent can be configured to randomly, sequentially, or in other suitable manners select one valid IP address for testing. In certain embodiments, the testing agent can be configured to execute a network testing procedure using the selected valid IP address (e.g., 192.168.0.1) and an IP address of the first network node. In other embodiments, the testing agent can be configured to randomly, sequentially, or in other suitable manners select another valid IP address behind the first network node (e.g., 10.1.1.1). The testing agent can then be configured to execute a network testing procedure using both the selected valid IP addresses, e.g., 192.168.0.1 and 10.1.1.1.

Upon obtaining results of the executed network testing procedure, the testing agent can be configured to report the obtained results to a network controller or other suitable components in the computer network. In certain embodiments, the reported results can be associated with the determined network prefix of the second network node. In other embodiments, the reported results can be associated with the pair of selected IP addresses used for executing the network testing procedure. The testing agent can also be configured to periodically repeat the foregoing operations while selecting different IP addresses behind the first and/or second network nodes. As such, different network routes in the computer network can be tested over time and can effectively discover grey failures in the computer network.

Several embodiments of the disclosed technology can efficiently perform failure detection in a computer network in a cost effective manner. The testing agent deployed on network nodes in the computer network can vary the selected IP addresses behind the network nodes for each network testing procedure. As such, the testing agent can execute network testing procedures along various network routes in the computer network. Thus, different network routes can be tested to discover grey failures in the computer network without deploying canary servers. For instance, when the network controller determines that all network traffic directed to IP addresses behind the second network node has failed even though the second network node appears to be active, the network controller can be configured to indicate that the second network node may have suffered a grey failure.

### BRIEF DESCRIPTION OF THE DRAWINGS

FIG. 1 is a schematic diagram illustrating a distributed computing system having a computer network organized in a hierarchical structure in accordance with embodiments of the present technology.

FIGS. 2A-2D are schematic diagram illustrating certain hardware/software components of the computer network of FIG. 1 during certain operations of route discovery for failure detection in accordance with embodiments of the disclosed technology.

FIG. 3A is a schematic diagram illustrating certain hardware/software components of a network controller suitable for the distributed computing system of FIG. 1 in accordance with embodiments of the present technology.

FIG. 3B illustrate an example network traffic diagram useful by the network controller of FIG. 3A to detect hardware/software failures in the computer network of FIG. 1 in accordance with embodiments of the present technology.

FIGS. 4A and 4B are flowcharts illustrating certain processes of route discovery for failure detection in accordance with embodiments of the disclosed technology.

FIG. 5 is a computing device suitable for certain components of the computer network in FIG. 1.

### DETAILED DESCRIPTION

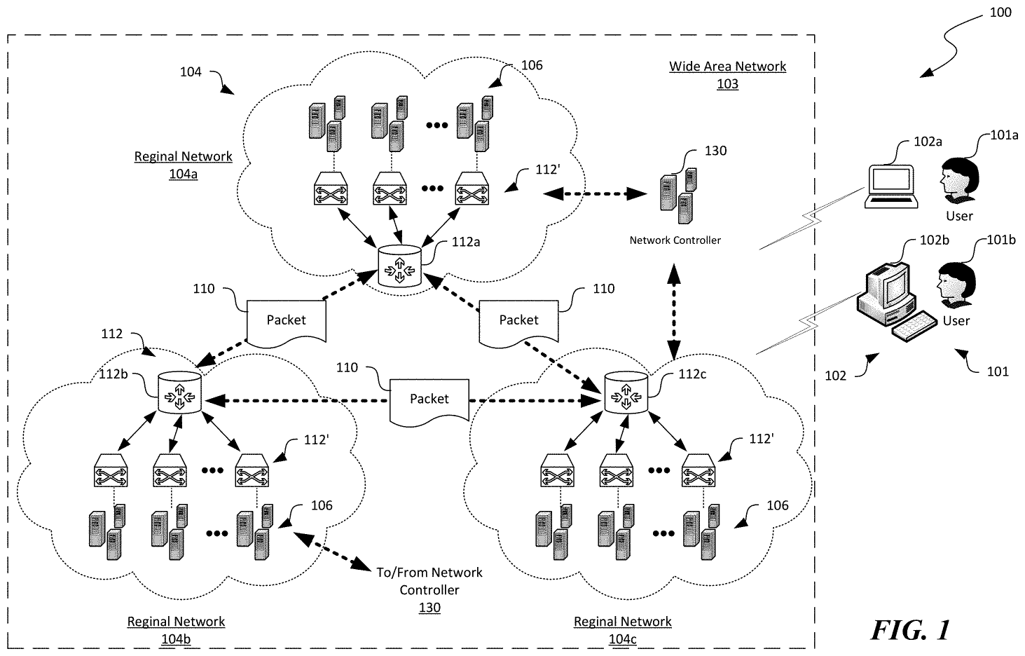

Certain embodiments of systems, devices, components, modules, routines, data structures, and processes for route discovery for failure detection in computer networks are described below. In the following description, specific details of components are included to provide a thorough understanding of certain embodiments of the disclosed technology. A person skilled in the relevant art will also understand that the technology can have additional embodiments. The technology can also be practiced without several of the details of the embodiments described below with reference to FIGS. 1-5.

Many terminologies are used herein to illustrate various aspects of the disclosed technology. Such terminologies are intended as examples and not definitions. For instance, a distributed computing system can be a computing facility having a computer network interconnecting a plurality of host machines to one another or to external networks (e.g., the Internet). An example of such a computing facility can include a cloud computing system having multiple datacenters for providing cloud computing services to users. A computer network can include a plurality of network nodes. A network node can be a physical network device, examples of which include routers, switches, hubs, bridges, load balancers, security gateways, or firewalls. A network node can also include virtualized network devices such as a virtualized switch, router, load balancer, etc.

A host machine or host can include a computing device that is configured to implement, for instance, one or more virtual machines, containers, or other suitable virtualized components for providing suitable computing services. For example, a host can include a computer server having a hypervisor configured to support one or more virtual machines. In another example, a host can include a virtual machine or other suitable types of software component configured to host a container or other suitable types of virtual components.

In another example, a computing service or cloud service can include one or more computing resources provided over a computer network such as the Internet. Example cloud services include software as a service (SaaS), platform as a service (PaaS), and infrastructure as a service (IaaS). SaaS is a software distribution technique in which software applications are hosted by a cloud service provider in, for instance, datacenters, and accessed by users over a computer network. PaaS generally includes delivery of operating systems and associated services over the computer network without requiring downloads or installation. IaaS generally includes outsourcing equipment used to support storage, hardware, servers, network devices, or other components, all of which are made accessible over a computer network.

An endpoint in a computer network can include a physical or software emulated computing device. Example end points include network servers, network storage devices, personal computers, mobile computing devices (e.g., smartphones), virtual machines, containers, applications, etc. Each endpoint may be associated with a network address in a computer network. One example network address is an IP address having a numerical label assigned to each device connected to a computer network that uses the Internet Protocol for communication. For instance, a network node can have an IP address of 192.168.0.1 according to one IP addressing version. Network addresses can also be aggregated into a network prefix indicating a collection of network addresses. For example, IP addresses starting from 192.168.0.0 to 192.168.255.255 can be aggregated to 192.168.0.0/16, which indicate that the first sixteen bits of 192.168.0.0 are the prefix for these IP addresses.

In certain computer networks, network nodes can advertise certain network prefixes to other network nodes to indicate that all communication traffic directed to any network addresses in the aggregated network prefix are to be delivered to the advertising network nodes. Such communications can be exchanged according to the Border Gateway Protocol (“BGP”). As such, BGP neighbors can establish a TCP session on a designated port (e.g., 179). The BGP neighbors can also send keep-alive messages periodically, (e.g., every 60 seconds) to maintain the established BGP session.

A computer network can also include a domain name system (DNS) that is configured to translate alphanumerical domain names into routable network addresses such as numerical IP addresses to effect communications in the computer network. For example, a domain nameserver can translate domain name “www.example.com” to IP address 192.168.0.1. Routers, switches, or other computer services or devices can then access computing resources associated with this domain name (e.g., “www.example.com”) based on the translated IP address (e.g., 192.168.0.1). Typically, a domain name system can include one or more operatively coupled DNS servers with access to a database having resource records of domain name translations.

Large computer networks can often have network nodes arranged in a hierarchical structure. For instance, in a WAN, regional computer networks can include many switches or routers interconnected to one another in a multi-level topology. Multiple backbone switches can then interconnect the multiple regional computer networks to one another. Backbone switches, routers, and other network nodes, however, can suffer various hardware or software failures that interrupt communication traffic in the computer network. For example, a backbone switch may appear to have an active link to a regional computer network, e.g., a connection to the backbone switch appears to be active. However, the backbone switch may not be able to receive and/or forward any packets from/to the regional computer network.

One technique to automate detection of such failures is by deploying dedicated diagnostic servers in multiple regional computer networks of the WAN. The diagnostic servers can periodically transmit testing packets to one another via the WAN. If testing packets fail to arrive, the diagnostic servers can then indicate a network event or failure along particular network routes of the testing packets. Deploying diagnosis servers though can be costly and ineffective. For example, a pair of diagnostic servers can typically only test limited numbers of network routes in the computer network because the source and destination of testing packets are fixed. Thus, the diagnosis servers may not detect grey failures along other network routes used by other servers in the WAN.

Several embodiments of the disclosed technology can address certain aspects of the foregoing difficulties by implementing a network controller interconnected to a testing agent executing on individual network nodes (e.g., backbone switches or routers) in a computer network for detecting hardware/software failures in the computer network. In certain implementations, a testing agent on a network node can access a database to identify another network node connected to the network node via the computer network. The testing agent can then determine whether a BGP session is active between the network nodes. When a BGP session is inactive, the testing agent can effectuate a network testing procedure to the network address of the other network node.

When a BGP session is active, the testing agent can then identify a network prefix advertised by the other network node and consult a DNS server in the computer network to determine which one or more of network addresses aggregated in the network prefix is valid and routable. The testing agent can then randomly, sequentially, or in other suitable manners select one of the network addresses and effect a network testing procedure to the selected network address. Subsequently, the testing agent can select other valid and routable network addresses in the network prefix and effect additional network testing procedures to collect data representing network connection status in the computer network. With the collected data, the network controller can be configured to effectively determine whether a failure is present in the computer network as well as a potential location of the failure, as described in more detail below with reference to FIGS. 1-5.

FIG. 1 is a schematic diagram illustrating a distributed computing system 100 having a computer network organized in a hierarchical structure in accordance with embodiments of the present technology. As shown in FIG. 1, the distributed computing system 100 can include a WAN 103 interconnected to client devices 102 of users 101. The client devices 102 can individually include a computing device that facilitates access to various resources or computing services via the WAN 103 by the users 101. In the illustrative embodiment, the first computing device 102a includes a laptop computer while the second computing device 102b includes a desktop computer. In other embodiments, the client devices 102 can also include smartphones or other suitable computing devices. Though only two users 101 are shown for illustration purposes, in other implementations, the distributed computing system 100 can include any suitable numbers of users 101.

As shown in FIG. 1, the WAN 103 can include multiple regional networks 104 interconnected to one another via edge network nodes 112. Each regional network 104 can include multiple internal network nodes 112′ interconnecting multiple hosts 106 together. In the following description, the edge and internal network nodes 112 and 112′ are collectively referred to as network nodes 112 unless explicitly labeled. Though only one edge network node 112 is shown in FIG. 1 in each regional network 104, in further implementations, each regional network 104 can include multiple edge network nodes 112 (not shown) configured to interface with other edge network nodes 112 in the other regional networks 104.

The individual regional networks 104 can have the same or different network topology from one another. For example, the first regional network 104a can be arranged in a mesh configuration while the second regional network 104b can have a hierarchical configuration. In other examples, at least two of the regional networks 104 can have the same of similar network topologies. Though three regional networks 104 are shown in FIG. 1, in other implementations, the WAN 103 can include two, four, five, or any other suitable numbers of regional networks 104 interconnected with corresponding edge network nodes 112.

The edge network nodes 112 can individually include one or more switches, routers, or other suitable types of network devices configured to facilitate communications of endpoints, such as the hosts 106 or any components hosted thereon. For example, the first edge network node 112a can receive a packet 110 from a host 106 in the first regional network 104a and destined to another host 106 in the second regional network 104b. The first edge network node 112a can be configured to determine that routing to the other host 106 in the second regional network 104b is through the second edge network node 112b. Thus, the first edge network node 112a forwards the packet 110 to the second edge network node 112b, which in turn forwards the packet 110 to the other host 106 in the second regional network 106. Similar operations can also be performed between the second and third edge network node 112b and 112c and between the first and third edge network nodes 112a and 112c.

In operation, hosts 106 in various regional networks 104 can cooperate with one another to provide desired computing services to the users 101. For example, the first user 101a can request email, file management, or other suitable types of computing services. In response, the hosts 106 in different regional networks 104 can cooperate with one another to provide the request computing services to the user 101. For instance, a web server on one host 106 in the first regional network 104a can request a database server on another host 106 in the second regional network 104b for records of documents to be provided to the user 101. In turn, the database server can communicate the requested records to the web server via the edge network nodes 112. The web server can then forward the documents to the client device 102 of the user 101.

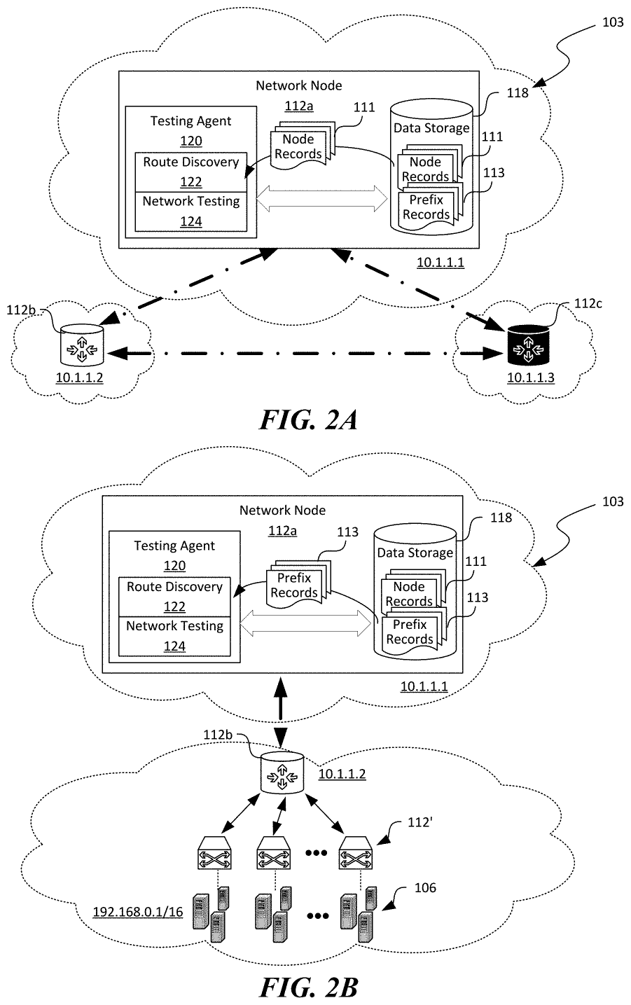

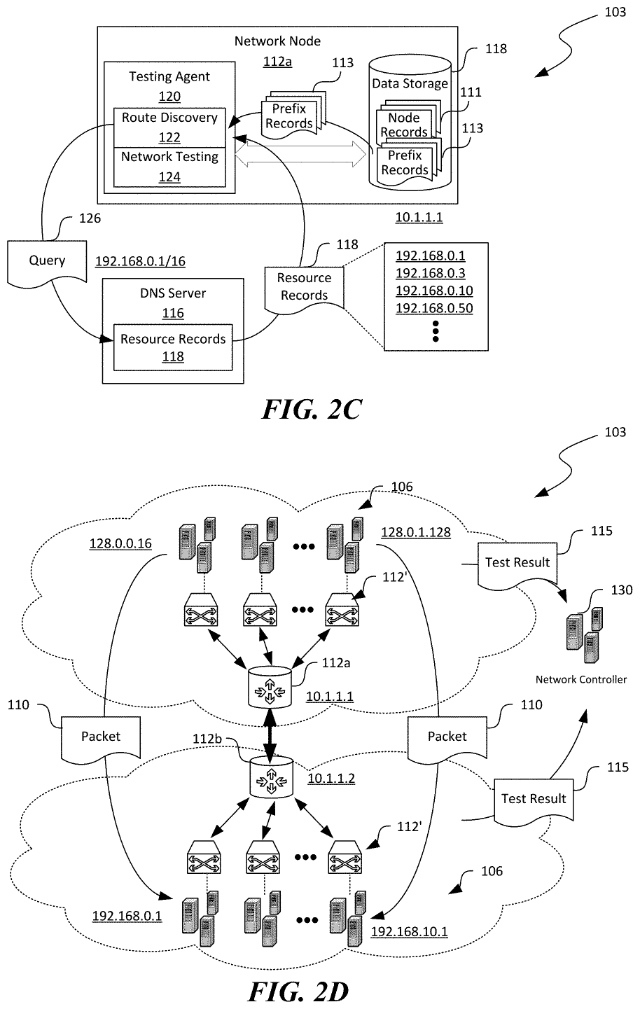

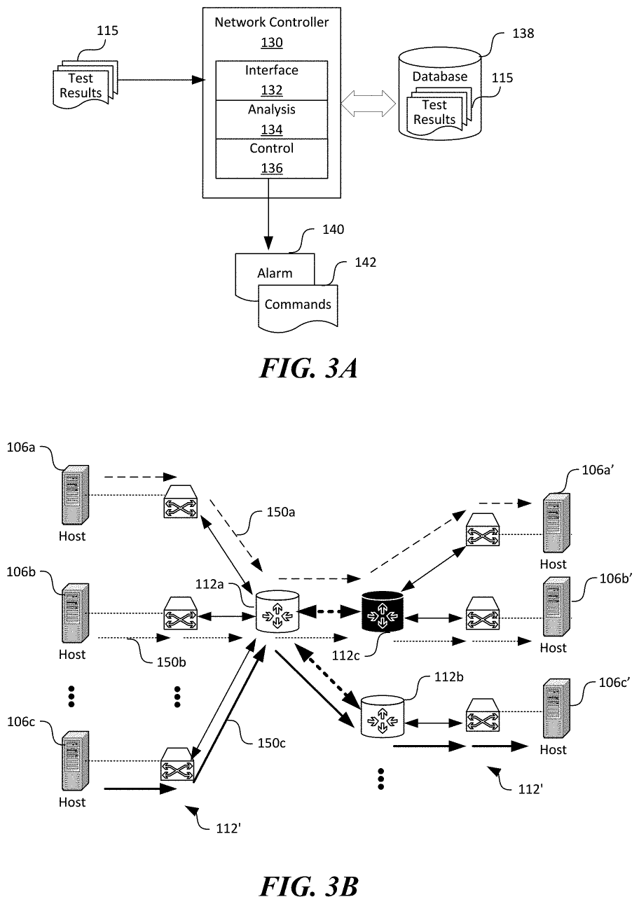

Sometimes, one or more network nodes 112 may appear to be active but fail to receive/transmit any packets 110, and thus negatively impact user experience of the provided computing service. As shown in FIG. 1, the WAN 103 can also include a network controller 130 configured to monitor and detect such hardware and/or software failures of network nodes 108 or 112 in the WAN 103. In certain implementations, the network nodes 112 can individually implement a testing agent 120 (shown in FIG. 2A) configured to perform dynamic route discovery and execution of network test procedures, as described in more detail below with reference to FIGS. 2A-2D. Upon completion of executing network test procedures, the testing agent 120 can provide test results to the network controller 130, which in turn can be configured to determine whether a hardware and/or software failure exists in the WAN 103 and a potential location of such a hardware and/or software failure, as described in more detail below with reference to FIGS. 3A and 3B.

FIGS. 2A-2D are schematic diagram illustrating certain hardware/software components of the WAN 103 of FIG. 1 during certain operations of route discovery for failure detection in accordance with embodiments of the disclosed technology. In FIGS. 2A-2D and in other Figures herein, individual software components, objects, classes, modules, and routines may be a computer program, procedure, or process written as source code in C, C++, C#, Java, and/or other suitable programming languages. A component may include, without limitation, one or more modules, objects, classes, routines, properties, processes, threads, executables, libraries, or other components. Components may be in source or binary form. Components may also include aspects of source code before compilation (e.g., classes, properties, procedures, routines), compiled binary units (e.g., libraries, executables), or artifacts instantiated and used at runtime (e.g., objects, processes, threads).

Components within a system may take different forms within the system. As one example, a system comprising a first component, a second component, and a third component. The foregoing components can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a tablet computer, a network server, a laptop computer, a smartphone, and/or other suitable computing devices.

Equally, components may include hardware circuitry. In certain examples, hardware may be considered fossilized software, and software may be considered liquefied hardware. As just one example, software instructions in a component may be burned to a Programmable Logic Array circuit or may be designed as a hardware component with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media. As used herein, the term “computer readable storage media” excludes propagated signals.

As shown in FIG. 2A, the network node 112 can include a data storage 118 interconnected to a testing agent 120 executing on the network node 112a for detecting hardware and/or software failures. The data storage 118 can contain node records 111 identifying other network nodes in the WAN 103 and prefix records 113 identifying prefixes advertised by other network nodes 112. In the illustrated embodiment, the testing agent 120 can include a route discovery component 122 and a network testing component 124 operatively coupled to each other. In other embodiments, the testing agent 120 can also include network, database, or other suitable types of components. In FIG. 2A, only the first edge network node 112a includes a testing agent 120 for illustration purposes. One or more of the other edge or internal network nodes 112 can also include a testing agent 120 (not shown) with similar or different components.

The route discovery component 122 can be configured to select a network route in the WAN 103 for executing a network test procedure. In certain implementations, the route discovery component 122 can be configured to initially access the node records 111 in the data storage 118 to discover other network nodes 112 interconnected to the first edge network node 112a in the WAN 103. For instance, by querying the node records 111 in an ISIS database, the route discovery component 122 at the first edge network node 112a can determine IP addresses of the second and third edge network nodes 112b and 112c connected to the first edge network node 112a via the WAN 103. Thus, in the illustrated example, the first edge network node 112a, which has an IP address of 10.1.1.1 can discover that the IP addresses for the second and third edge network nodes 112b and 112c are 10.1.1.2, and 10.1.1.3, respectively. In other examples, the route discovery component 122 may also determine a name, an ID, a Media Access Control (MAC) address, or other suitable identifiers of the other network nodes 112.

In certain implementations, the route discovery component 122 can be configured to filter the discovered network nodes 112 based on indications in the node records 111 that one or more discovered network nodes 112 are in maintenance. For example, a node record 111 may include data indicating that a “DBOverload” flag is set for a network node 112 (e.g., the third edge network node 112c). In response, the route discovery component 122 can ignore this network node 112 for performing network testing procedures because the third network node 112c is in maintenance (shown in reverse contrast in FIG. 2A). In another example, a node record 111 may include data indicating that all overload metrics of a network node 112 are at maximum values. In response, the route discovery component 122 can ignore this network node 112 as well for performing network testing procedures because the network node 112 is in maintenance. In further examples, the route discovery component 122 can be configured to filter the discovered network nodes 112 for performing network test procedures based on a whitelist, a blacklist, or in other suitable manners.

As shown in FIG. 2B, using the determined IP addresses, the route discovery component 122 on the first network node 112a can be configured to determine whether the second edge network node 112b exchanges routing information of endpoints connected with the first edge network node 112a. In one embodiment, the routing information can be exchanged during a BGP session between the first and second edge network nodes 112a and 112b. In response to determining that the first edge network node 112a does not have a BGP session with the second edge network node 112b, the network testing component 124 can be configured to execute a network testing procedure using an IP address of the first edge network node (e.g., 10.1.1.1) and the IP address of the second edge network node 112b (i.e., 10.1.1.2). Examples of a network testing procedure can include executing a Ping command, traceroute command, File Transfer Protocol (FTP) performance test, Hypertext Transfer Protocol (HTTP) availability test, or other suitable testing techniques. The network testing component 124 can be configured to then transmit data representing test results to the network controller 130 for further analysis.

As shown in FIG. 2B, in response to determining that the first edge network node 112a does have a BGP session with the second edge network node 112b, the route discovery component 122 can be configured to query the prefix records 113 in, for instance, a BGP database on the first edge network node 112a to determine one or more network prefixes that the second edge network node 112b is advertising to the first edge network node 112a. A network prefix is an aggregation of IP addresses. For example, IP addresses starting from 192.168.0.0 to 192.168.255.255 can be aggregated to 192.168.0.0/16, which indicate that the first sixteen bits of 192.168.0.0 are the prefix for these IP addresses, which could correspond to endpoints such as the hosts 106 (or components hosted thereon) in the second regional network 104b to be served by the second edge network node 112b. Thus, by advertising a network prefix of 192.168.0.0/16, the second edge network node 112b is indicating to the first edge network node 112a that all network traffic directed to any addresses covered by the network prefix, e.g., 192.168.0.0 to 192.168.255.255 are to be forwarded to the second edge network node 112b. In other examples, the prefixes can have 32, 24, 12, 8, or any other suitable number of bits.

However, not all IP addresses covered by the advertised network prefix are valid, i.e., associated with computing resources that can be reached via the WAN 103. Thus, as shown in FIG. 2C, upon obtaining the IP prefix (e.g., 192.168.0.1/16), the route discovery component 122 can be configured to consult a DNS server 116 containing resource records 118 to determine one or more IP addresses covered the obtained IP prefix are valid and routable IP addresses behind the second edge network node 112b. For example, the route discovery component 122 can submit a NSLookup command to the DNS server 116 to retrieve all resource records 118 from the DNS server 116. The individual resource records 118 can include corresponding domain names (e.g., example.com) and associated IP addresses (e.g., 192.168.0.1). Upon obtaining the resource records 118 from the DNS server 116, the route discovery component 122 can be configured to determine which one or more of the IP addresses aggregated in the determined network prefix is associated with a domain name. Those IP addresses associated with a domain name can be deemed as valid and routable while others not associated with a domain name are discarded.

By querying the DNS server 116 and scanning the resource records 118, the route discovery component 122 can be configured to determine that one or more IP addresses associated with the determined prefix are valid and routable. For instance, in the example above, the route discovery component 122 can be configured to determine that IP address 192.168.0.1 associated with the prefix 192.168.0.0/16 is a valid IP address because the IP address is associated with an active domain name, i.e., example.com. In another example, the route discovery component 122 can also determine that IP addresses 192.168.0.3, 192.168.0.10, and 192.168.0.50 are also valid IP addresses because these IP addresses individually correspond to active domain names (not shown in FIG. 2C).

As shown in FIG. 2D, upon determining one or more valid IP addresses, the network testing component 124 can be configured to randomly, sequentially, or in other suitable manners select one valid IP address from the one or more valid IP addresses for testing. In certain embodiments, the network testing component 124 can be configured to execute a network testing procedure using the selected valid IP address (e.g., 192.168.0.1) and an IP address of the first edge network node 112a (e.g., 10.1.1.1). In other embodiments, the network testing component 124 can be configured to randomly, sequentially, or in other suitable manners select another valid IP address behind the first edge network node 112a (e.g., 128.0.0.16 or 128.0.0.128). The network testing component 124 can then be configured to execute a network testing procedure using both the selected valid IP addresses, e.g., 192.168.0.1 and 128.0.0.16 or 128.0.0.128 by, for example, transmitting packets 110 between endpoints corresponding to the selected IP addresses.

Upon obtaining results of the executed network testing procedure, the network testing component 124 can be configured to transmit test results 115 to the network controller 130 for further analysis. In certain embodiments, the test results 115 can be associated with the determined network prefix of the second edge network node 112b. In other embodiments, the test results 115 can be associated with the pair of selected IP addresses used for executing the network testing procedure. The testing agent 120 can also be configured to periodically repeat the foregoing operations while selecting different IP addresses behind the first and/or second edge network nodes 112a and 112b. As such, different network routes in the WAN 103 can be tested over time and can effectively discover grey failures in the WAN 103.

Several embodiments of the disclosed technology can efficiently perform failure detection in the WAN 103 in a cost effective manner. The testing agent 120 deployed on network nodes 112 can vary the selected IP addresses behind the network nodes 112 for each network testing procedure. As such, the testing agent on multiple network nodes 112 can execute network testing procedures along various network routes in the WAN 103. Thus, different network routes can be tested to discover hardware and/or software failures in the WAN 103 without deploying canary servers. For instance, when the network controller 130 determines that all network traffic directed to IP addresses behind the second edge network node 112b has failed even though the second edge network node 112b appears to be active, the network controller 130 can be configured to indicate that the second edge network node 112b may have suffered a grey failure, as described in more detail below with reference to FIGS. 3A and 3B.

FIG. 3A is a schematic diagram illustrating certain hardware/software components of a network controller 130 suitable for the distributed computing system 100 of FIG. 1 in accordance with embodiments of the present technology. As shown in the embodiment of FIG. 3A, the network controller 130 can include an interface module 132, an analysis module 134, and a control module 136 operatively coupled to one another. In other embodiments, the network controller 130 can also include calculation, network, or other suitable types of modules.

The interface module 132 can be configured to receive test results 115 from the testing agent 120 (FIG. 2A) executing on one or more network nodes 112 in the WAN 103 of FIG. 1. The interface component 132 can also be configured to process the received test results 115 by, for example, inserting metadata of time stamps and storing the test results 115 in a database 138. The interface component 134 can then be configured to forward the test results 115 to the analysis module 134 for further processing.

The analysis module 134 can be configured to analyze the received test results 115 and determine whether any hardware and/or software failure is present in the WAN 103. For example, the analysis module 134 can be configured to generate a graph having nodes individually corresponding to each IP addresses, hosts, or network nodes in the WAN 103. Based on an indication of one or more communication failures in the test results 115, the analysis module 134 can be configured to indicate that a failure is present and a potential location of the failure. One example technique for detecting the failure is described in more detail below with reference to FIG. 3B.

The control module 136 can be configured to effect suitable actions based on analysis results from the analysis module 134. For example, as shown in FIG. 3A, the control module 136 can be configured to issue an alarm 140 to the hosts 106, network nodes 112 in the WAN 103 or other suitable entities upon detecting a failure. In certain embodiments, the control module 136 can also be configured to issue commands 142 to, for instance, a network node 112 believed to have experienced a failure to perform a remedial action, such as rebooting the network node 112 or perform other suitable actions.

FIG. 3B illustrate an example network traffic diagram useful by the network controller 130 of FIG. 3A to detect hardware/software failures in the computer network of FIG. 1 in accordance with embodiments of the present technology. As shown in FIG. 3B, the test results 115 (FIG. 2D) indicate that communication between a host 106a behind the first edge network node 112a and another host 106a′ behind the second edge network node 112b along a network path 150a has failed. The test results 115 also indicate that communication between a host 106b behind the first edge network node 112a and another host 106b′ behind the second edge network node 112b along another network path 150b has also failed. The test results 115 further indicate that communication between a host 106c behind the first edge network node 112a and another host 106c′ behind the third edge network node 112c along a further network path 150c has succeeded. As such, based on the test results 115, the analysis module 134 (FIG. 3A) can determine that the second edge network node 112b has failed because the second edge network node 112b is common to both network paths 150a and 150b.

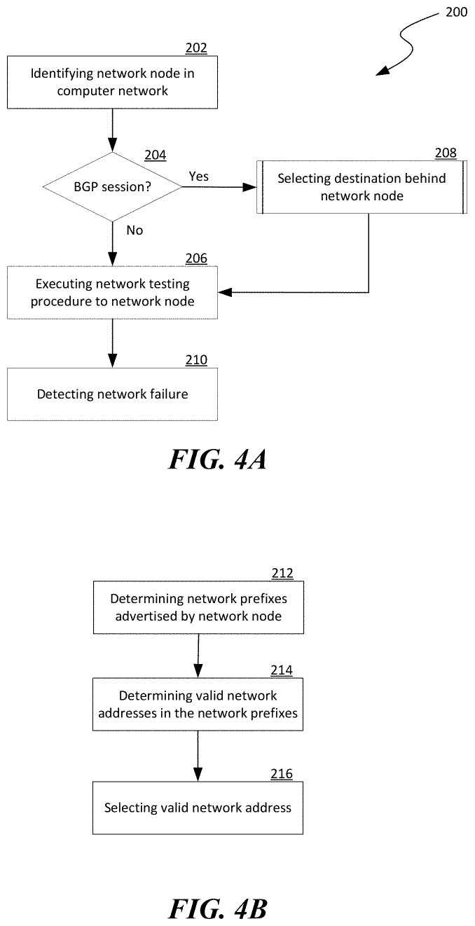

FIGS. 4A and 4B are flowcharts illustrating certain processes of route discovery for failure detection in accordance with embodiments of the disclosed technology. Even though embodiments of the processes are described below in the context of the distributed computing system 100 of FIG. 1, in other embodiments, the processes can be implemented in computing systems with additional and/or different components.

As shown in FIG. 4A, a process 200 can include identifying, at a network node, other network nodes in a computer network that are connected to the network node at stage 202. Example techniques of identifying the other network nodes are described above with reference to FIG. 2A. The process 200 can then include a decision stage 204 to determine whether the network node has a BGP session with one of the identified network nodes. In response to determining that the network node does not have a BGP session with one of the identified network nodes, the process 200 proceeds to executing a network testing procedure using a network address of the one of the identified network nodes at stage 206. Example techniques of executing a network testing procedure are described above with reference to FIG. 2A. The process 200 can then proceed to detecting network failures based on the executed network testing procedure at stage 210. Example techniques of detecting network failure are described above with reference to FIGS. 3A and 3B. In response to determining that the network node does have a BGP session with one of the identified network nodes, the process 200 proceeds to selecting a destination behind the one of the identified network nodes at stage 208 before proceeding to executing a network testing procedure at stage 206. Examples operations of selecting the destination are described in more detail below with reference to FIG. 4B.

As shown in FIG. 4B, example operations of selecting a destination can include determining one or more network prefixes advertised by the one of the identified network nodes at stage 212. The operations can then proceed to determining one or more valid network addresses in the network prefix at stage 214. Examples operations of determining one or more valid network addresses are described in more detail below with reference to FIG. 2C. The operations can then proceed to selecting a network address from the one or more valid network addresses at stage 216.

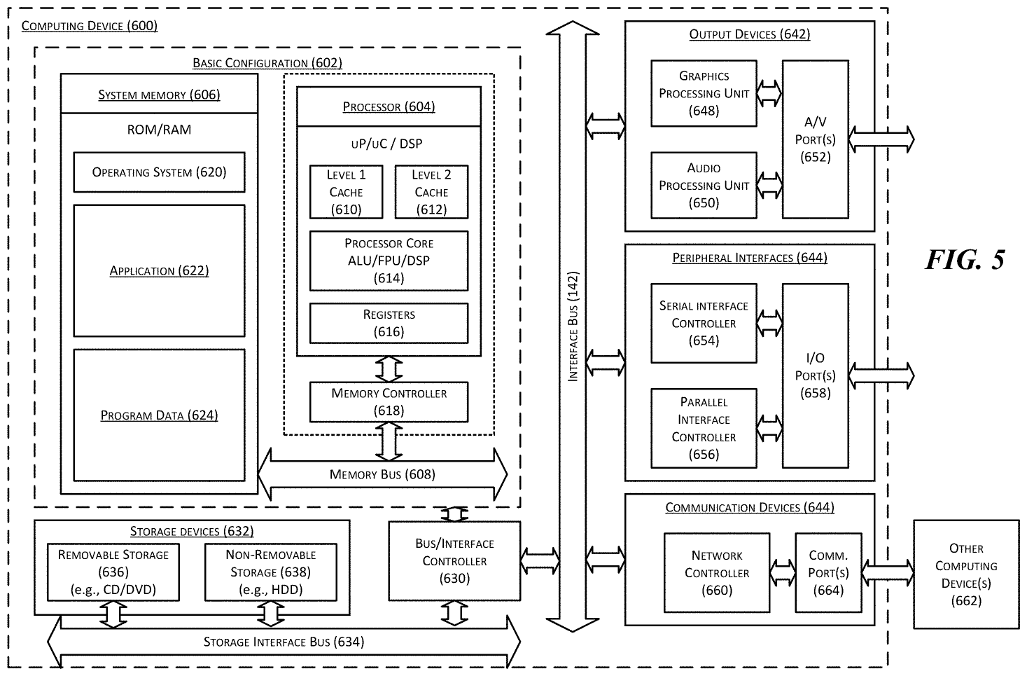

FIG. 5 is a computing device 300 suitable for certain components of the distributed computing system 100 in FIG. 1. For example, the computing device 300 can be suitable for the hosts 106, the client device 102, the network nodes 112, or the network controller 130 of FIG. 1. In a very basic configuration 302, the computing device 300 can include one or more processors 304 and a system memory 306. A memory bus 308 can be used for communicating between processor 304 and system memory 306.

Depending on the desired configuration, the processor 304 can be of any type including but not limited to a microprocessor (μP), a microcontroller (μC), a digital signal processor (DSP), or any combination thereof. The processor 304 can include one more level of caching, such as a level-one cache 310 and a level-two cache 312, a processor core 314, and registers 316. An example processor core 314 can include an arithmetic logic unit (ALU), a floating-point unit (FPU), a digital signal processing core (DSP Core), or any combination thereof. An example memory controller 318 can also be used with processor 304, or in some implementations memory controller 318 can be an internal part of processor 304.

Depending on the desired configuration, the system memory 306 can be of any type including but not limited to volatile memory (such as RAM), non-volatile memory (such as ROM, flash memory, etc.) or any combination thereof. The system memory 306 can include an operating system 320, one or more applications 322, and program data 324. The computing device 300 can have additional features or functionality, and additional interfaces to facilitate communications between basic configuration 302 and any other devices and interfaces. For example, a bus/interface controller 330 can be used to facilitate communications between the basic configuration 302 and one or more data storage devices 332 via a storage interface bus 334. The data storage devices 332 can be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable, and non-removable media implemented in any method or technology for storage of information, such as computer readable instructions, data structures, program modules, or other data. The term “computer readable storage media” or “computer readable storage device” excludes propagated signals and communication media.

The system memory 306, removable storage devices 336, and non-removable storage devices 338 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information, and which can be accessed by computing device 300. Any such computer readable storage media can be a part of computing device 300. The term “computer readable storage medium” excludes propagated signals and communication media.

The computing device 300 can also include an interface bus 340 for facilitating communication from various interface devices (e.g., output devices 342, peripheral interfaces 344, and communication devices 346) to the basic configuration 302 via bus/interface controller 330. Example output devices 342 include a graphics processing unit 348 and an audio processing unit 350, which can be configured to communicate to various external devices such as a display or speakers via one or more NV ports 352. Example peripheral interfaces 344 include a serial interface controller 354 or a parallel interface controller 356, which can be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which can be arranged to facilitate communications with one or more other computing devices 362 over a network communication link via one or more communication ports 364.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

The computing device 300 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 300 can also be implemented as a personal computer including both laptop computer and non-laptop computer configurations.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

I/We claim:

1. A method of route discovery for failure detection in a computer network having multiple network nodes, comprising:
accessing an Intermediate System-to-Intermediate System (ISIS) database at a first network node to identify a second network node connected to the first network node via the computer network;
determining, at the first network node, whether the second network node has a Border Gate Protocol (BGP) session with the first network node; and
in response to determining that the second network node has a BGP session with the first network node,
identifying a network prefix advertised by the second network node to the first network node;
determining, based on the identified network prefix, multiple network addresses in the identified network prefix that correspond to network reachable endpoints connected to the second network node;
selecting one of the determined multiple network addresses corresponding to network reachable endpoints;
executing, in the computer network, a network test procedure to produce data indicating a connection status to the selected one of the determined multiple network addresses corresponding to network reachable endpoints connected to the second network node; and
based on the produced data, determining whether the first or second network node suffers from a hardware or software failure.

2. The method of claim 1, further comprising:
in response to determining that the second network node does not have a BGP session with the first network node, executing, in the computer network, the network test procedure to produce data indicating a connection status to a network address of the second network node.

3. The method of claim 1, further comprising:
subsequently to executing the network test procedure,
selecting another network address from the determined multiple network addresses corresponding to network reachable endpoints; and
executing, in the computer network, another network test procedure to produce additional data indicating another connection status to the selected another network address.

4. The method of claim 1 wherein determining the multiple network addresses in the identified network prefix that correspond to network reachable endpoints connected to the second network node includes:
for each of the network addresses aggregated in the network prefix,
consulting a Domain Name System (DNS) server in the computer network to determine whether the each of the network addresses corresponds to a domain name; and
in response to determining that the each of the network addresses corresponds to a domain name in the DNS, designating the each of the IP addresses as corresponding to a network reachable endpoint in the computer network.

6. A method of route discovery for failure detection in a computer network having multiple network nodes, comprising:
accessing a database at a first network node to identify a second network node connected to the first network node via the computer network;
determining, at the first network node, whether the second network node exchanges with the first network node routing information of network endpoints connected to the second network node; and
in response to determining that the second network node exchanges with the first network node routing information of network endpoints,
identifying, from the exchanged routing information, a network prefix corresponding to the second network node;
determining, based on the identified network prefix, one or more network addresses in the identified network prefix corresponding to one or more network reachable endpoints connected to the second network node;
executing, in the computer network, a network test procedure to produce data indicating a connection status to at least one of the determined one or more network addresses corresponding to network reachable endpoints connected to the second network node; and
based on the produced data, detecting hardware/software failures exists in the computer network.

7. The method of claim 6 wherein:
accessing the database include accessing an Intermediate System-to-Intermediate System (ISIS) database on the first network node to identify the second network node, the identified second network node having an Internet Protocol (IP) address and a router identifier; and
the method further includes, in response to determining that the second network node does not exchange with the first network node routing information of network endpoints, executing, in the computer network, the network test procedure to produce data indicating a connection status to the IP address of the second network node.

8. The method of claim 6 wherein:
determining whether the second network node exchanges with the first network node routing information includes determining, at the first network node, whether the second network node has a Border Gate Protocol (BGP) session with the first network node; and
in response to determining that the second network node does not have a BGP session with the first network node, executing, in the computer network, the network test procedure to produce data indicating a connection status to the IP address of the second network node.

9. The method of claim 6 wherein:
determining whether the second network node exchanges with the first network node routing information includes determining, at the first network node, whether the second network node has a Border Gate Protocol (BGP) session with the first network node; and
in response to determining that the second network node does have a BGP session with the first network node, performing the identifying, determining, executing, and detecting operations.

10. The method of claim 6 wherein:
identifying the network prefix includes identifying a network prefix that covers multiple Internet Protocol (IP) addresses; and
determining one or more network addresses in the identified network prefix includes determining one or more IP addresses corresponding to one or more network reachable endpoints connected to the second network node by consulting a Domain Name System (DNS) server.

11. The method of claim 6 wherein:
identifying the network prefix includes identifying a network prefix that covers multiple Internet Protocol (IP) addresses; and
determining the one or more network addresses in the identified network prefix includes:
for each of the IP addresses aggregated in the network prefix,
consulting a Domain Name System (DNS) server in the computer network to determine whether the each of the IP addresses corresponds to a domain name; and
in response to determining that the each of the IP addresses corresponds to a domain name in the DNS, designating the each of the IP addresses as corresponding to a network reachable endpoint in the computer network.

12. The method of claim 6 wherein:
identifying the network prefix includes identifying a network prefix that covers multiple Internet Protocol (IP) addresses;
determining one or more network addresses in the identified network prefix includes determining one or more IP addresses corresponding to one or more network reachable endpoints connected to the second network node by consulting a Domain Name System (DNS) server;
the method further includes randomly selecting one of the one or more IP addresses corresponding to one or more network reachable endpoints connected to the second network node; and
executing the network test procedure includes executing, in the computer network, the network test procedure to produce data indicating a connection status to the randomly selected one of the one or more IP addresses corresponding to network reachable network endpoints connected to the second network node.

13. The method of claim 6, further comprising:
determining, at the first network node, another network address corresponding to another endpoint connected to the first network node; and
wherein executing the network test procedure includes executing, in the computer network, the network test procedure to produce data indicating a connection status between
the another network address corresponding to another endpoint connected to the first network node; and
at least one of the determined one or more network addresses corresponding to network reachable network endpoints connected to the second network node.

14. The method of claim 6 wherein:
determining the one or more network addresses includes determining multiple network addresses in the identified network prefix corresponding to multiple network reachable endpoints connected to the second network node, respectively;
the method further includes selecting a first network address from the multiple network addresses;
executing the network test procedure includes executing, in the computer network, the network test procedure to produce data indicating a connection status to the selected first network address; and
the method further includes, subsequently,
randomly selecting a second network address from the multiple network addresses, the second network address being different than the first network address; and
re-executing the network test procedure to produce additional data indicating another connection status to the selected second network address.

15. A computing device in a computer network having multiple network nodes, comprising:
a processor; and
a memory operatively coupled to the processor, the memory including instructions executable by the processor to cause the computing device to:
access a database at a first network node to identify a second network node connected to the first network node via the computer network;
determine, at the first network node, whether the second network node exchanges with the first network node routing information of network endpoints connected to the second network node; and
in response to determining that the second network node exchanges with the first network node routing information of network endpoints connected to the second network node,
identify, from the exchanged routing information, a network prefix advertised by the second network node to the first network node;
determine, based on the identified network prefix, one or more network addresses in the identified network prefix corresponding to one or more network reachable endpoints connected to the second network node; and
execute, in the computer network, a network test procedure to produce data indicating a connection status to at least one of the determined one or more network addresses corresponding to network reachable endpoints connected to the second network node.

15. The computing device of claim 14 wherein the memory includes additional instructions executable by the processor to cause the computing device to:
in response to determining that the second network node does not exchange with the first network node routing information of network endpoints, execute, in the computer network, the network test procedure to produce data indicating a connection status to a network address of the second network node.

16. The computing device of claim 14 wherein to determine the one or more network addresses in the identified network prefix includes to determine one or more IP addresses corresponding to one or more network reachable endpoints connected to the second network node by consulting a Domain Name System (DNS) server in the computer network.

17. The computing device of claim 14 wherein:
to identify the network prefix includes to identify a network prefix that covers multiple Internet Protocol (IP) addresses; and
to determine the one or more network addresses in the identified network prefix includes:
for each of the IP addresses aggregated in the network prefix,
determine, based on Domain Name System (DNS) resource records, whether the each of the IP addresses corresponds to a domain name; and
in response to determining that the each of the IP addresses corresponds to a domain name in the DNS resource records,
designating the each of the IP addresses as corresponding to a network reachable endpoint in the computer network.

18. The computing device of claim 14 wherein the memory includes additional instructions executable by the processor to cause the computing device to:
randomly select one of the one or more network addresses corresponding to one or more network reachable endpoints connected to the second network node; and
execute, in the computer network, the network test procedure to produce data indicating a connection status to the randomly selected one of the one or more network addresses corresponding to network reachable network endpoints connected to the second network node.

19. The computing device of claim 14 wherein the memory includes additional instructions executable by the processor to cause the computing device to:
determine another network address corresponding to another endpoint connected to the first network node; and
wherein to execute the network test procedure includes to execute, in the computer network, a network test procedure to produce data indicating a connection status between
the another network address corresponding to another endpoint connected to the first network node; and
at least one of the determined one or more network addresses corresponding to network reachable network endpoints connected to the second network node.

20. The computing device of claim 14 wherein:
the one or more network addresses include multiple network addresses aggregated in the identified network prefix corresponding to multiple network reachable endpoints connected to the second network node, respectively;
the memory includes additional instructions executable by the processor to cause the computing device to:
select a first network address from the multiple network addresses;
execute, in the computer network, a network test procedure to produce data indicating a connection status to the selected first network address; and
subsequently,
randomly select a second network address from the multiple network addresses, the second network address being different than the first network address; and
re-executing the network test procedure to produce additional data indicating another connection status to the selected second network address.
